(19) United States
(12) Patent Application Publication
(10) Pub. No.: US 2012/0128928 A1
(43) Pub. Date: May 24, 2012

(54) APERTURE REINFORCEMENT STRUCTURE

(75) Inventors: Herbert Chidsey Roberts, III, Simpsonville, SC (US); Roger Lee Ken Matsumoto, Newark, DE (US)

(73) Assignee: GENERAL ELECTRIC COMPANY, Schenectady, NY (US)

(21) Appl. No.: 12/949,385

(22) Filed: Nov. 18, 2010

(51) Int. Cl. B32B 3/24

(52) U.S. Cl. 428/138

(57) ABSTRACT

Aspects of the invention provide for an aperture reinforcement structure. In one embodiment, a composite laminate is disclosed, including: a first sheet of material having a first aperture therein; a second sheet of material having a second aperture therein corresponding to the first aperture; and a reinforcement structure having: a continuous fiber including a plurality of convolutions affixed to at least one of the first sheet of material or the second sheet of material, the plurality of convolutions surrounding at least one of the first aperture or the second aperture; and a resin binding the plurality of convolutions to one another.

### BACKGROUND OF THE INVENTION

The subject matter disclosed herein relates to an aperture reinforcement structure. Specifically, the subject matter disclosed herein relates to a structure for reinforcing an aperture (or, hole) in a material, and an associated method of forming the reinforcing structure.

A structure such as a flat plate or a shell having a hole, may be over-stressed if the load transfer between the structure's hole and an associated mating pin or bolt exceeds the shear strength of the structure's material. For example, shear tear-out at the hole location can occur in both a monolithic structure (e.g., a plate), as well as in a structure made of composite materials.

Plates or more complex structures composed of composite materials can have orthotropic properties, where the strength and stiffness of such a composite material will be greater in the direction parallel to its fibers than in a direction transverse to the fibers. Stresses applied proximate to a hole in such an orthotropic material can exceed the shear strength or tensile strength of the structure's material property in the parallel direction, the transverse direction, and or a direction between parallel and transverse.

### BRIEF DESCRIPTION OF THE INVENTION

Aspects of the invention provide for an aperture reinforcement structure. In one embodiment, a composite laminate is disclosed, including: a first sheet of material having a first aperture therein; a second sheet of material having a second aperture therein corresponding to the first aperture; and a reinforcement structure having: a continuous fiber including a plurality of convolutions affixed to at least one of the first sheet of material or the second sheet of material, the plurality of convolutions surrounding at least one of the first aperture or the second aperture; and a resin binding the plurality of convolutions to one another.

A first aspect of the invention includes a composite laminate having: a first sheet of material including a first aperture therein; a second sheet of material having a second aperture therein corresponding to the first aperture; and a reinforcement structure having: a continuous fiber including a plurality of convolutions affixed to at least one of the first sheet of material or the second sheet of material, the plurality of convolutions surrounding at least one of the first aperture or the second aperture; and a resin binding the plurality of convolutions to one another.

A second aspect of the invention includes a composite laminate having: a plurality of stacked sheets of material each including a substantially circular aperture therein, each of the substantially circular apertures being substantially aligned; and a plurality of reinforcement structures interspersed between the plurality of stacked sheets of material, each of the plurality of reinforcement structures having: a continuous fiber including a plurality of convolutions affixed to at least one of the plurality of stacked sheets of material, the plurality of convolutions surrounding the substantially circular apertures; and a resin binding the plurality of convolutions to one another.

A third aspect of the invention includes a reinforced monolithic material including: a single sheet of material having a substantially circular aperture therein; and a reinforcement structure affixed to the single sheet of material, the reinforcement structure including: a continuous fiber having a plurality of convolutions affixed to the single sheet of material, the plurality of convolutions surrounding the substantially circular aperture; and a resin binding the plurality of convolutions to one another.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-3 show cut-away top views of conventional material reinforcement systems.

FIG. 4 shows a top isolation view of a reinforcement structure according to embodiments of the invention.

FIG. 5 shows a three-dimensional perspective view of a system for creating a reinforcement structure according to embodiments of the invention.

FIG. 6 shows a partial cut-away side view of a system for creating a reinforcement structure according to embodiments of the invention.

FIG. 7 shows a cut-away top view of a composite laminate including a reinforcement structure according to embodiments of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As discussed herein, conventional approaches to address a composite structure's material property limitations are to include an alternating pattern of cross-ply laminate, with an alternating ninety-degree orientation. This conventional method is performed in order to align the composite laminate's fibers in more than one direction, which serves to counteract the strength limitation of the composite material's orthotropic properties. However, the cross-ply laminate approach still only addresses the material strength limitations in two directions (e.g., parallel to the material fiber and transverse to the material fiber). It may still fail to prevent edge cracking, shear-based failure cracking, etc. in directions other than parallel and transverse to the material's fibers.

In contrast to conventional approaches, aspects of the invention include a spiral wound fiber which provides circumferential reinforcement of a hole in a structure. These aspects of the invention may allow for reinforcement of a hole in a structure, regardless of the orientation of the structure in a final part. Aspects of the invention may provide for reduced edge cracking and shear-based failure cracking as compared to conventional hole-reinforcement mechanisms.

For example, in one embodiment, a composite laminate is disclosed, the composite laminate including: a) a first sheet of material having a first aperture therein; b) a second sheet of material having a second aperture therein corresponding to the first aperture; and c) a reinforcement structure including: a continuous fiber having a plurality of convolutions affixed to at least one of the first sheet of material or the second sheet of material, the plurality of convolutions surrounding at least one of the first aperture or the second aperture; and a resin binding the plurality of convolutions to one another.

In another embodiment, aspects of the invention provide for a method of forming a reinforcement structure configured to reinforce an aperture in a material (e.g., in a composite or a monolithic material). In some embodiments, the method may include winding a fiber around a central mandrel between a pair of guide discs, and binding the fiber to itself using a resin-based slurry to form a reinforcement structure.

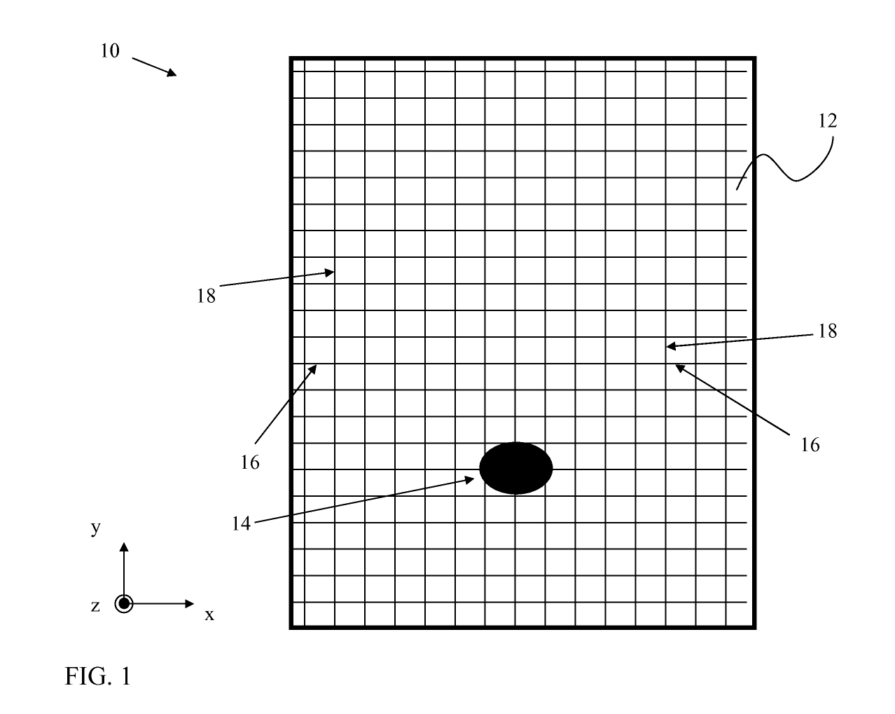

Turning to FIG. 1, a cut-away top view of a conventional material reinforcement system 10 is shown. In this conventional system, a piece of material (e.g., a sheet of monolithic or composite material) 12 is shown including an aperture 14. In one embodiment, the aperture 14 extends substantially through the material 12 in the z-direction (into the page, along the z-axis). It is understood that aperture 14 may be configured to receive a coupling member such as a pin, bolt, rivet, screw, etc. (not shown). Also shown in reinforcement system 10 are cross-ply reinforcement structures 16, 18, which may be affixed to material 12 as a laminate, or may be formed within the original material 12 (e.g., as an insert). As shown, the cross-ply reinforcement structure includes reinforcement members 16, 18 intersecting at approximately ninety-degree angles (along the x-axis and y-axis, respectively). In any case, as described with reference to the conventional approaches of reinforcing materials having apertures, cross-ply reinforcement structures 16, 18 may fail to prevent material failures such as edge cracking and/or shear-based failure cracking in directions other than along the x and y axes.

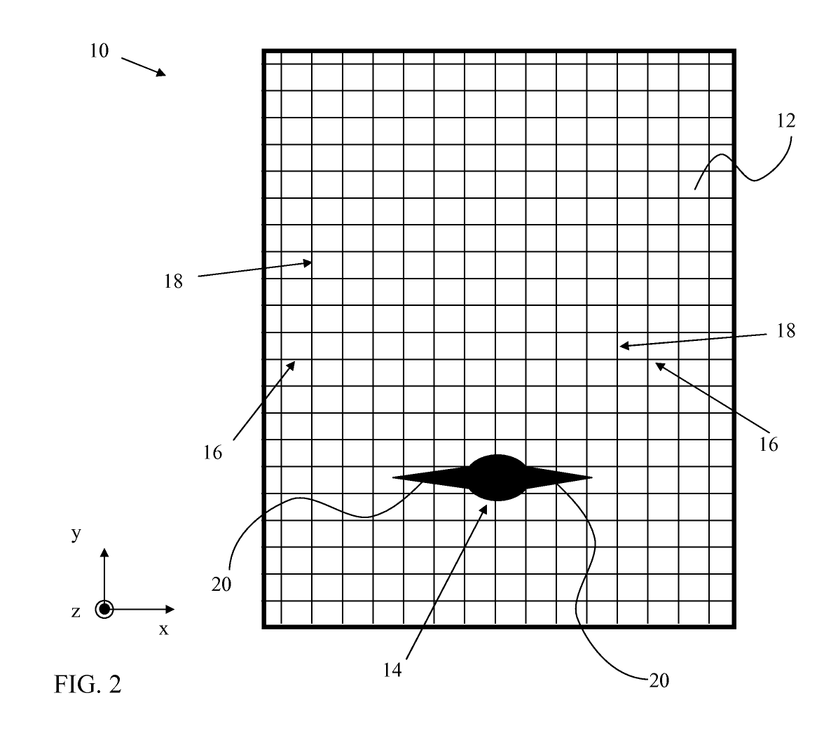

FIG. 2 shows the conventional material reinforcement system 10 of FIG. 1, and further illustrating edge cracking 20 proximate to aperture 14. As described herein, edge cracking 20 may occur, e.g., due to a “tear-out” or other force applied along the z-axis (into or out of the page), normal to the planar surface of the sheet of material 12. In this case, for example, movement of a pin or bolt through the aperture 14 may cause edge cracking 20, and subsequently, material failure.

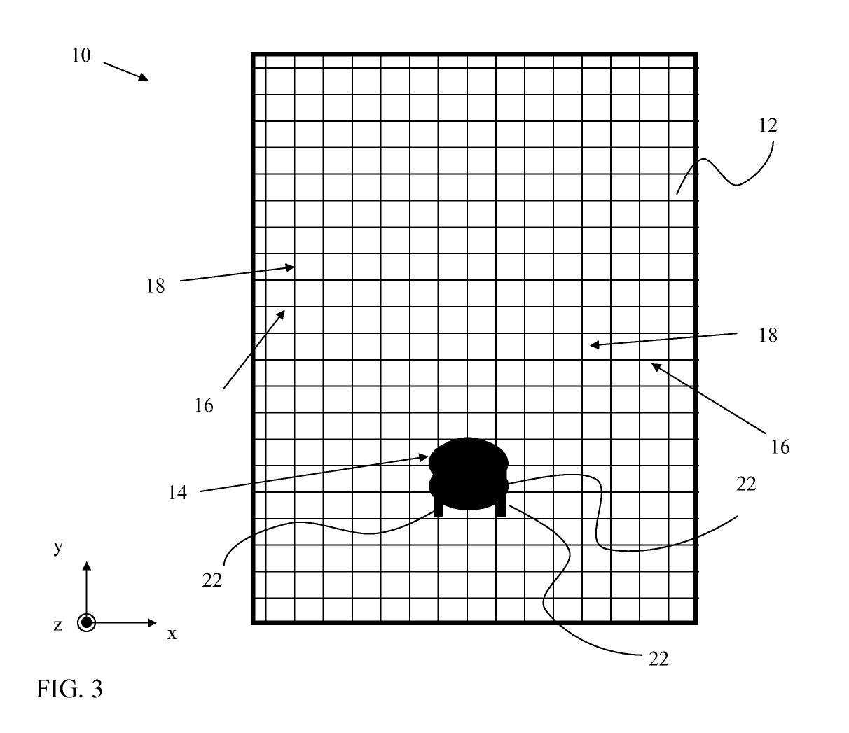

FIG. 3 shows the conventional material reinforcement system 10 of FIG. 1, and further illustrating shear-based failure cracking 22 proximate to aperture 14. As described herein, shear-based failure cracking 22 may occur due to application of a force along the y-axis (or, e.g., the x-axis in other cases) within the aperture 14 that is greater than the cross-ply reinforcement structures 18 (or 16, along the x-axis) can bear. This leads to an elongation of the original aperture 14, and cracking along the y-axis proximate to the original aperture 14. This force applied along the y-axis (or, x-axis, or x-y axis, etc. in other cases), may be applied by a bolt, screw, pin or other member received within the aperture 14. For example, a pin may experience a shearing force in the y-axis direction and transfer that shearing force to the inner surfaces of aperture 14, thereby elongating the aperture.

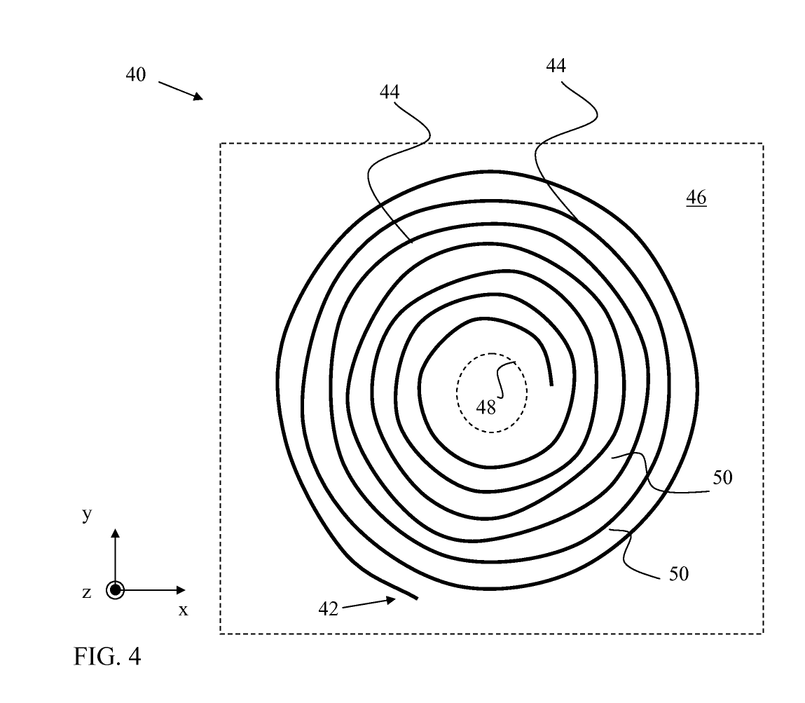

Turning to FIG. 4, a top isolation view of a reinforcement structure 40 is shown according to embodiments of the invention. As shown, reinforcement structure 40 may include a continuous fiber 42 having a plurality of convolutions 44 affixed to at least one sheet of material 46 (shown in phantom) for reinforcing an aperture 48 therein. It is understood that material 46 and aperture 48 are shown in phantom to illustrate that reinforcement structure 40 may be formed separately from material 46 and later attached, via, e.g., lamination to one or more sheets of material 46. Convolutions 44 of the fiber 42 may form substantially concentric revolutions about aperture 48, which in this embodiment, is a circular hole. It is understood, however, that other convolutions, e.g., oblong convolutions, may also be used to reinforce, for example, an oblong-shaped aperture. In one embodiment, fiber 42 may be approximately 0.015 to 0.020 centimeters wide, with a stiffness of greater than forty degrees of tow bend angle. As is known in the art, the term “tow” may refer to the structure of the fiber 42, in that the fiber 42 may be composed of a plurality of fiber elements wound about a common axis, as in a thread. A conventional “droop angle” test may be used to determine the stiffness of fiber 42, where, in one embodiment, the fiber 42 has approximately 2 centimeters of droop per ten centimeters of unsupported length of fiber 42. Also shown between convolutions 44 is a resin 50, used to bind each adjacent convolution 44 to one another. As will be described further herein, resin 50 may be formed of, e.g., a polyvinylbutyral polymer binder, that may be semi rigid at room temperature, allowing for manipulation during the assembly process. Resin 50 may be formed between adjacent convolutions 44 having a thickness of approximately 0.015 to 0.020 centimeters. In one embodiment, resin 50 may be applied to fiber 42 before fiber 42 is wound into convolutions 44, as is described further herein. It is understood that in some embodiments, resin 50 may be applied to fiber 42 during formation of convolutions 44 prior to affixing the fiber 42 to the material 46.

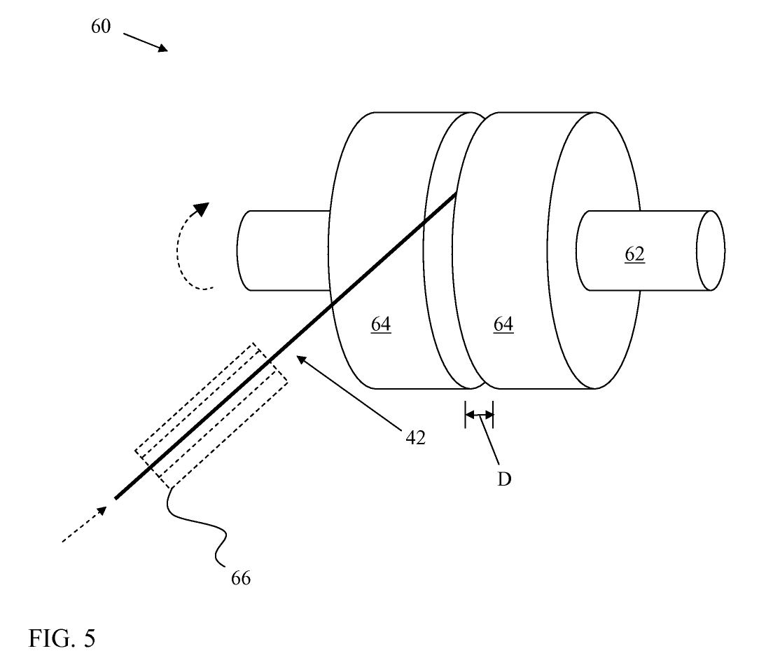

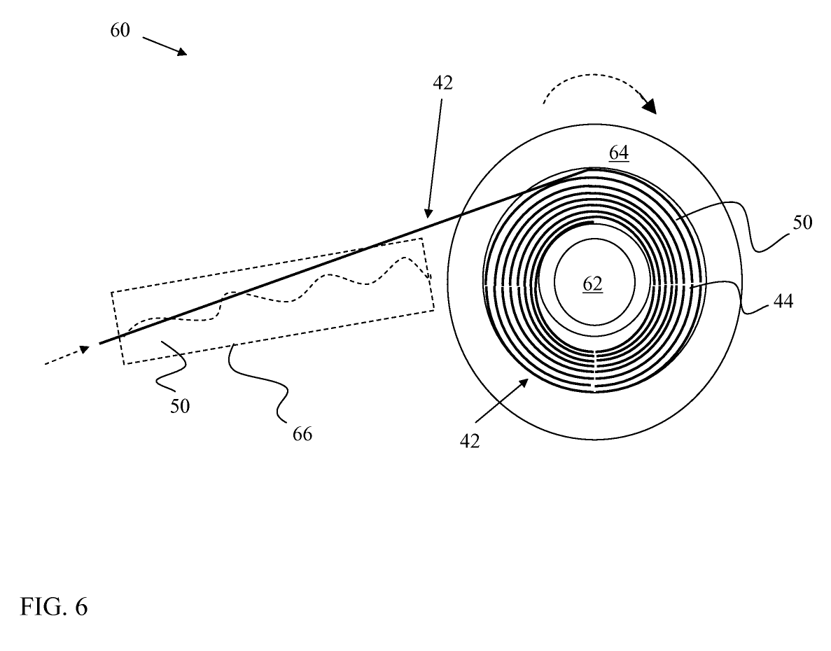

Turning to FIGS. 5 and 6, a three-dimensional perspective view and a partial cut-away side view, respectively of a system 60 for creating a reinforcement structure (e.g., reinforcement structure 40 of FIG. 4) are shown. In one embodiment, system 60 may include a mandrel 62, a pair of guide discs 64, and a slurry tray 66 (shown schematically in FIGS. 5-6). As indicated by dashed arrows, fiber 42 may be wound around mandrel 62, via rotation of mandrel 62 (e.g., clockwise in FIG. 6). That is, a first end of fiber 42 may be affixed to a surface of mandrel 62 (e.g., via a chemical or mechanical fixture such as an adhesive or a pin), and the mandrel 62 may be rotated by an operator (e.g., a human operator or a machine). Mandrel 62 may pull fiber 42, while guide discs 64 control movement of the fiber 42 along the rotational axis of mandrel 62, such that each convolution 44 (FIG. 6) of fiber 42 is wound over an adjacent convolution 44, creating a substantially concentric structure. In one embodiment, guide discs 64 are located approximately 0.018 to 0.024 centimeters apart (distance, D), which may be a distance greater than a thickness of fiber 42, but less than a thickness of two contacting segments of fiber 42. In one embodiment, fiber 42 may be fed through the slurry tray 66 to substantially coat an outer surface of fiber 42 with a resin 50 (FIG. 6), before winding around mandrel 62. Resin 50 may include an adhesive capable of binding adjacent convolutions 44 of fiber 42 together as they wind around mandrel 62. Further, resin 50 may be configured to react to heat in some embodiments. For example, in some cases, resin 50 may be consumable, e.g., during a burn out phase (e.g., at approximately 400 degrees Celsius) when mixing of the resin 50 and the fiber 42 is not desirable. In other cases, the resin 50 may become integrated with the fiber 42 when the composite (of fiber 42 and resin 50) is processed to consolidation (e.g., via heating and subsequent cooling within an engineered process environment). In any case, whether resin 50 is retained or consumed, one or more processes described herein may have the technical effect of forming a reinforcement structure (e.g., reinforcement structure 40) capable of being attached to (or, integrated with) a sheet of material. While shown and described herein primarily as continuously wound convolutions 44 of fiber 42, it is understood that one or more convolutions 44 of fiber 42 may be formed separately (e.g., as circumferential reinforcement members such as rings) and attached to one another. That is, each convolution may be formed via the system 60 of FIGS. 5 and 6, but in some cases, adjacent convolutions may be bound together, e.g., via a resin without being continuously wound around mandrel 62.

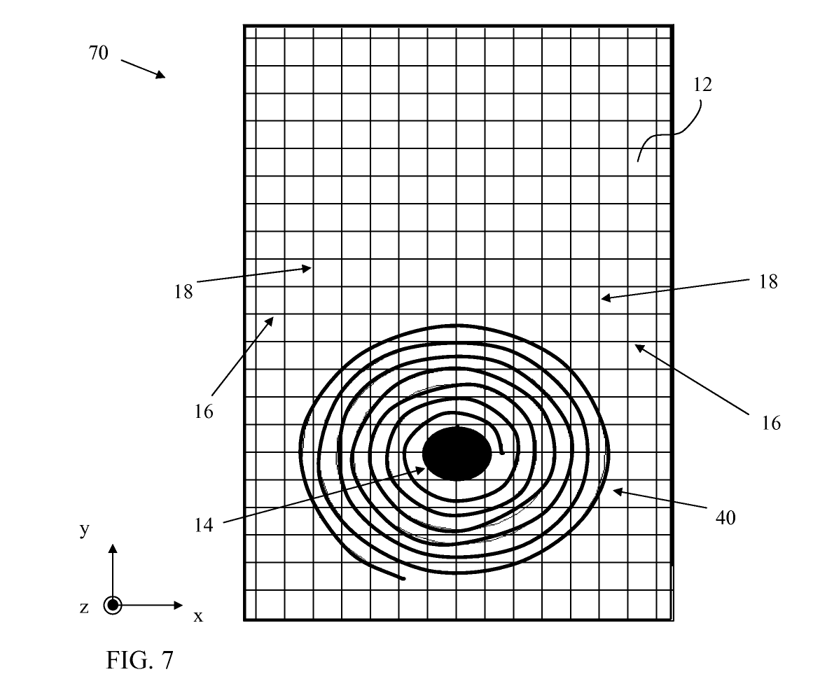

Turning to FIG. 7, a cut-away top view of a composite laminate 70 is shown according to embodiments of the invention. In one embodiment, composite laminate 70 includes a first sheet of material 12 (e.g., a sheet metal such as steel, aluminum, etc.) having an aperture 14 therein. In some embodiments, the first sheet of material 12 (or other sheets of material in a composite laminate) may be substantially orthotropic. That is, these orthotropic materials have a strength and stiffness that is greater in a direction parallel to the material fibers than in directions transverse to the material fibers. It is understood that composite laminate 70 may include a plurality of sheets of material 12, stacked upon one another (e.g., along the z-axis, where at least two of those sheets of material 12 include apertures 14 therein. It is further understood that each of the apertures 14 in the plurality of sheets of material 12 may be substantially aligned such that a hole extends through the plurality of sheets of material 12. These additional sheets of material 12 are omitted from this cut-away view for clarity of illustration.

Also shown in FIG. 7, composite laminate 70 may include a reinforcement structure 40 according to embodiments described herein. Reinforcement structure 40 may be substantially similar to the reinforcement structure 40 described with reference to FIGS. 4-6, and may be formed according to the methods described with particular reference to FIGS. 5-6. As shown, reinforcement structure 40 may be configured to substantially surround the aperture 14, and provide reinforcement of the aperture 14 via a plurality of convolutions (e.g., substantially circular convolutions). Composite laminate 70 is also shown including the cross-ply reinforcement structures 16, 18 described with reference to conventional material sheets. However, in one embodiment, the reinforcement structure 40 may replace one or more segments of the cross-ply reinforcement structures 16, 18, such that a sheet of material (e.g., material 12) may include one or more apertures (e.g., aperture 14) reinforced by reinforcement structure 40, and not cross-ply reinforcement structures 16, 18.

As described herein, reinforcement structure 40 may have a thickness (along the z-axis) equal to approximately a width of the fiber 42. That is, reinforcement structure 40 may take up no greater than approximately a width of the fiber 42 in the z-direction. This may allow for placement of reinforcement structure 40 between layers of material (e.g., material 12) in a composite laminate, within a monolithic layer of material, or affixed to a layer of material without substantially increasing the thickness of the material-reinforcement structure combination.

As described herein, aspects of the invention allow for more effective reinforcement of apertures in a material, e.g., a monolithic material or a composite, as compared with conventional approaches. In contrast to conventional reinforcement systems, the reinforcement structures of embodiments of the invention may be capable of reinforcing an aperture across a 360-degree span within a plane. That is, stresses applied at angles other than along the x and x axes of a material (e.g., along the positive x-y axis, negative x-y axis, etc.) may be reduced by the reinforcement structures described herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A composite laminate including:
a first sheet of material having a first aperture therein;
a second sheet of material having a second aperture therein corresponding to the first aperture; and
a reinforcement structure having:
a continuous fiber including a plurality of convolutions affixed to at least one of the first sheet of material or the second sheet of material, the plurality of convolutions surrounding at least one of the first aperture or the second aperture; and
a resin binding the plurality of convolutions to one another.

2. The composite laminate of claim 1, wherein the fiber has a stiffness of greater than forty degrees of tow bend angle.

3. The composite laminate of claim 1, wherein the resin has a thickness of approximately 0.018 to 0.024 centimeters between the plurality of convolutions.

4. The composite laminate of claim 1, wherein the reinforcement structure has a thickness equal to approximately a width of the continuous fiber.

5. The composite laminate of claim 1, wherein at least one of the first sheet of material or the second sheet of material is orthotropic.

6. The composite laminate of claim 1, wherein the first aperture and the second aperture are substantially circular.

7. The composite laminate of claim 6, wherein the plurality of convolutions are substantially concentric about the at least one of the first aperture or the second aperture.

8. A composite laminate including:
a plurality of stacked sheets of material each having a substantially circular aperture therein, each of the substantially circular apertures being substantially aligned; and
a plurality of reinforcement structures interspersed between the plurality of stacked sheets of material, each of the plurality of reinforcement structures having:
a continuous fiber including a plurality of convolutions affixed to at least one of the plurality of stacked sheets of material, the plurality of convolutions surrounding the substantially circular apertures; and
a resin binding the plurality of convolutions to one another.

9. The composite laminate of claim 8, wherein the fiber has a stiffness of greater than forty degrees of tow bend angle.

10. The composite laminate of claim 8, wherein the resin has a thickness of approximately 0.018 to 0.024 centimeters between the plurality of convolutions.

11. The composite laminate of claim 8, wherein the plurality of convolutions are substantially concentric about the substantially circular apertures.

12. The composite laminate of claim 8, wherein each of the reinforcement structures has a thickness equal to approximately a width of the continuous fiber.

13. The composite laminate of claim 8, wherein at least one of the first sheet of material or the second sheet of material is orthotropic.

14. A reinforced monolithic material including:
a single sheet of material having an aperture therein; and
a reinforcement structure affixed to the single sheet of material, the reinforcement structure including:
a continuous fiber including a plurality of convolutions affixed to the single sheet of material, the plurality of convolutions surrounding the aperture; and
a resin binding the plurality of convolutions to one another.

15. The reinforced monolithic material of claim 14, wherein the fiber has a stiffness of greater than forty degrees of tow bend angle.

16. The reinforced monolithic material claim 15, wherein the resin has a thickness of approximately 0.018 to 0.024 centimeters between the plurality of convolutions.

17. The reinforced monolithic material of claim 14, wherein the reinforcement structure has a thickness equal to approximately a width of the continuous fiber.

18. The reinforced monolithic material of claim 14, wherein the single sheet of material is orthotropic.

19. The reinforced monolithic material of claim 14, wherein the aperture is substantially circular.

20. The reinforced monolithic material of claim 19, wherein the plurality of convolutions are substantially concentric about the substantially circular aperture.
